(19) United States
(12) Patent Application Publication
(10) Pub. No.: US 2016/0275789 A1
(43) Pub. Date: Sep. 22, 2016

(54) Red Light Runner Traffic Light Control

(71) Applicant: Vance Pencheon, Basseterre (KN)

(72) Inventor: Vance Pencheon, Basseterre (KN)

(21) Appl. No.: 14/672,224

(22) Filed: Mar. 29, 2015

Related U.S. Application Data
(60) Provisional application No. 61/971,842, filed on Mar. 28, 2014.

(51) Int. Cl. G08G 1/07; H04N 7/18; G08G 1/017

(52) U.S. Cl. CPC G08G 1/07; G08G 1/0175; H04N 7/188

(57) ABSTRACT

The present invention is a system of circuits, lights, sensors and control added to the ordinary three light traffic light system that may have controller, timing and sensors in order to alter the working pattern of red and green lights for waiting drivers at the intersection and to cause the red light or additional red light to flash, and to delay green light. If a driver were to run a red light or the change from yellow (amber) light to red light activation, then waiting drivers in cross traffic are restrain by a flashing red light and a delayed green light.

This application claims priority to U.S. Provisional Application 61/971,842 filed on 28 Mar. 2014, the entire disclosure of which is incorporated by reference.

### TECHNICAL FIELD AND BACKGROUND

The present invention is a system of circuits, lights, sensors and control added to the ordinary three light traffic light system that may have controller, timing and sensors in order to alter the working pattern of red and green lights for waiting drivers at the intersection and to cause the red light or additional red light to flash, and to delay the green light when a vehicle runs the red light in the cross traffic. If a driver of a vehicle were to run a red light or run through the change from yellow (amber) light to red light activation, then waiting drivers in cross traffic are restrain by a flashing red light and a delayed green light for their lanes.

More specifically, the present invention changes to the working pattern of the red and the green lights and ads a flashing red light to the three light traffic light, so as to prevent the green light from coming on when there are red light runners in cross traffic. To accomplish this change, a sensor delay controller is positioned at the edge of the road side in a corner overlooking the traffic or moving vehicles area of the intersection. The sensor controller detects moving vehicles in the area of the intersection after receiving signal from original controller that the vehicle passed or already triggered any road sensor leading up to the edge of the intersection that would have normally caused the lights for the moving vehicle to switch from yellow to red and activated the green light for cross traffic. Such a vehicle is therefore, running a red light by being in the intersection during that vehicle's red light. When the sensor controller detects the vehicle in the intersection that should not be there, the sensor controller activates a relay. The relay then cuts the current to the green light of the cross or waiting traffic and on the other pole of the relay then powers a flashing circuit that supplies a flashing red light in very close proximity to the red light of the waiting or cross traffic. A delay time is inserted in the sensor controller so that when the vehicle running the red light clears the intersection the sensor controller can deactivate the relay putting its contacts in the normal position to provide connection from the green light output of the original control to the effected green light of the waiting or cross traffic.

The flashing red light might be a red light bulb with two filaments with a modified bulb socket with three terminals. The flashing red light might be a strobe light mounted in close proximity to the original red light.

The present invention could be incorporated in a new traffic light controller or in the embodiment below added to an original controller.

The added red light runner system of the present invention provides protection from accidents caused by a red light runner vehicle or emergency vehicles.

Traffic light cameras at the traffic light intersection of the present invention could use signals of the new sensor controller or original controller to coordinate, capture of the red runner vehicle and drivers that might try to purposely take advantage of the red light running system described above.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is an environmental drawing of the traffic light intersection for before a vehicle runs through the red light, in accordance with one embodiment of the present invention;

FIG. 2 is an environmental drawing of the traffic light intersection for as a vehicle runs through the red light, in accordance with one embodiment of the present invention;

FIG. 3 is a circuit diagram to explain the operation and devices added, in accordance with a further embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase “generally” does not refer to the same embodiment, however, it may. The terms “comprising”, “having” and “including” are synonymous, unless the context dictates otherwise.

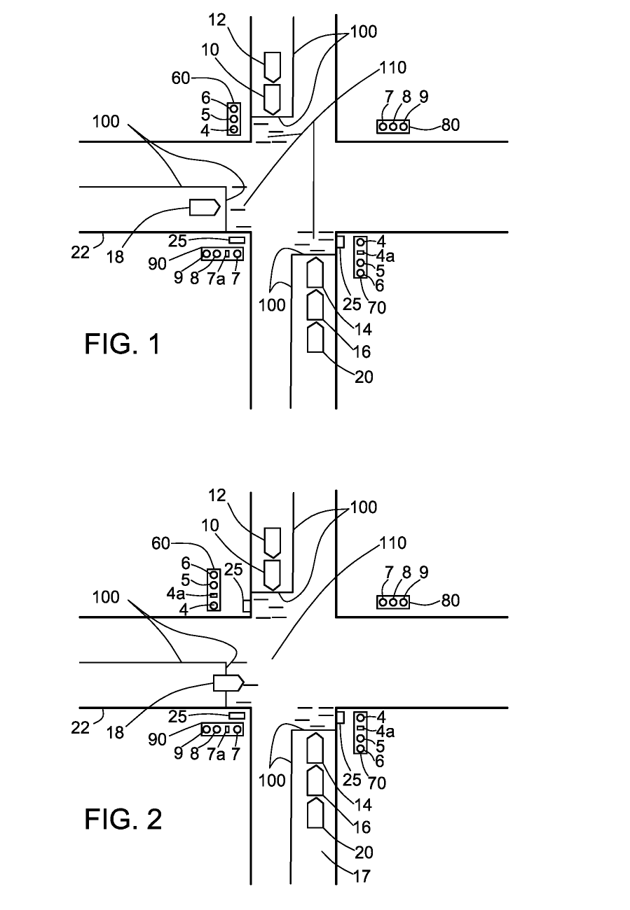

In an embodiment, FIG. 1 illustrates the sequence in which a red light running vehicle 18 just starts to run through the intersection as it reaches the edge of the intersection lanes 22 and while the cross, already waiting traffic 10, 12, 14, 16 are stopped at the intersection lanes 20. Sensor 25 is shown at the stop line 100 radiating ultrasonic or radar or infrared waves 110 into the areas immediately beyond the stop line 100 for moving vehicles in that specific lane 20 and 22. The best results are obtained if sensor controller 25 detection waves are limited to only the area beyond the stop line 100. A sensor controller 25 will be positioned at each stop line 100 in both sides of lanes 20 and 22.

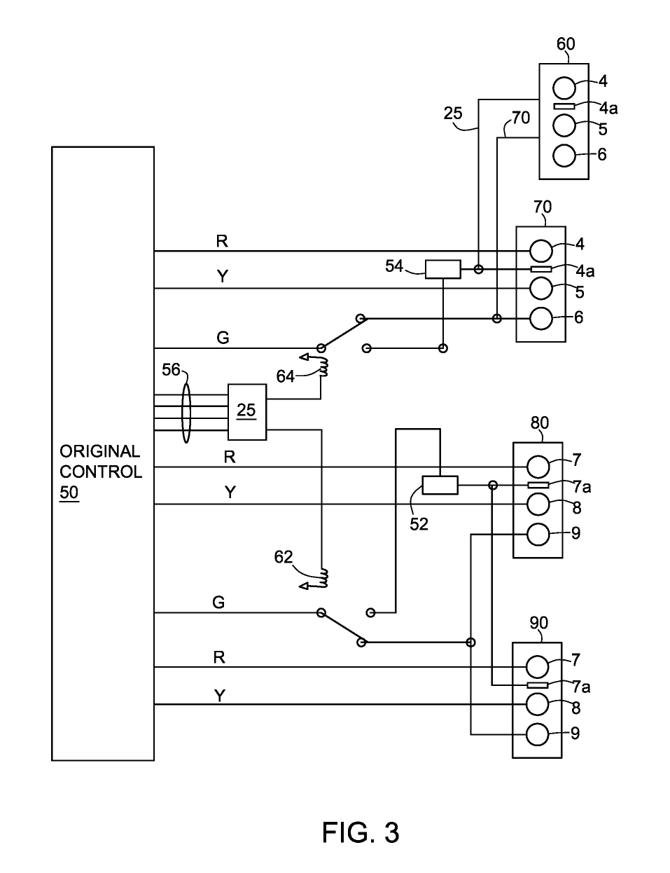

In an embodiment, FIG. 2 illustrates the next step in the sequence in which vehicle 18 has passed into the common area of the intersection defined by the lanes 22 and 20. At this point sensor controller 25 receives a signal from original controller 50 over bus 56 indicating the road sensors in traffic lane 22 have no or few vehicles and the yellow light for lanes 22 has been activated or the yellow light 8 to red light 7 activation transitions for lanes 22 has occurred. Then as sensor controller 25 senses a running red light vehicle 18 in the common intersection area defined by lanes 20 and 22, the sensor controller 25 will activate the relay 64 as shown in FIG. 3.

In FIG. 3, when relay 64 is activated, green light signal output from the original controller 50 is connected through closed (energized) relay contacts to provide power to flasher circuit 54 and is disconnected from the green light 6 for the waiting traffic in lanes 22 and flashing red light 4a will be flashing. At this point original controller 50 will have activated the yellow light 5 and a little later activated red light 4 in lane 20 and will have output signals to the sensor controller 25 over bus 56. In FIGS. 2 and 3, while sensor controller 25 continues to detect the running red light vehicle 18 in the intersection area from lane 22, vehicles 14 and 16 will not see a green light 6 and will see the flashing red light 4a, until the red runner vehicle 18 finishes moving through the intersection area. At that point, when no vehicle 18 is sensed by the sensor controller 25, the relay 64 is deactivated and the green signal is connected through the normally open, (unactivated) contacts to the green light 6 turning it on and flash circuit 54 receives no power or signal so as to turn off flashing light 4a. Then vehicles 14 and 16 are alerted to safely drive through the intersection from lane 20 cross lane 22.

If in FIG. 2 the vehicle had not run the yellow light 8 and/or red light 7, signals from the original controller 50 are sent through bus 56 indicating that the red light 7 has started in lane 22 and red 5 light activation is ended and the green light should turn on in lane 20. Then vehicles 14 and 16 waiting to go through the intersection are safe to driver through lane 20 across lane 22. Then in FIG. 3, sensor controller would sense no vehicle 18 in the intersection area and would keep relay 64 from activating. Thus, green light signal from original controller 50 is connected through the normally open contacts (nonactivated) of relay 64 to green light 6.

As is well understood elements relay 62 and flash circuit 52, and common elements 25, 50 and 56 and red light 7, flashing light 7a, yellow light 8 and green light 9 in lane 22 operate in the similar manner as described above if a red light running vehicle was detected in the intersection area coming from lane 20 to alert that traffic in lane 22 to not proceed.

As is well understood by one of ordinary skill in the art the embodiment of the circuit and operation described and presented via FIG. 3 could be incorporated into one whole new traffic light controller and new fourth flashing red light added to all three light traffic lights. In other words, the relay 62, flashing circuit 52 and the logic operations of the sensor controller 25 describe above are incorporated as software in a whole new traffic light controller.

The original controller sensors and the original controller and the sensor controller 25 all have signals that can assist in the triggering of a camera type red runner vehicle capture system. Such red runner vehicle capture system can help with traffic that might intentionally take advantage of the red light runner traffic lights.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. A red light runner traffic light controller comprising,
a sensor controller coupled to receive signals from an original controller,
the sensor controller is positioned to detect a red running vehicle at a stop line of the intersection of two crossing lanes on both sides of the lanes,
a relay coupled to the output of the sensor controller,
a green light signal for waiting traffic lanes output from the original controller is coupled to the normally open contacts of the relay,
a green light for waiting lanes is coupled to the normally open contacts of the relay,
a flashing circuit coupled to the closed contacts of the relay thus receiving output from the green light signal when the relay is activated by the output of the sensor controller,
a flashing red light for the waiting lanes of the intersection is coupled to an output of the flashing light circuit to output flashing red light,
wherein when the sensor controller detects a red runner vehicle within a common area of the intersection and has received the output from the original controller that the red runner vehicle passed original controller sensors leading up to the intersection and the original controller has decided to light a yellow light for a lane of the red runner vehicle, the sensor controller activates the relay which in turn disconnects the green light for the waiting lanes output by the original controller to prevent the green light from lighting for traffic in the waiting lanes and sends the green light signal to the flashing circuit through the relay connected to the flashing light of the waiting lanes;
wherein when the sensor controller does not detect a red runner vehicle and the original controller sensors confirm recently stopped traffic in the lanes of the red runner vehicle, the relay does not activate and the original controller operates based on normal timing and output of the original controller sensors to output the green light in the waiting lanes normally and the red flashing light does not flash in the waiting lanes.

2. The red light runner traffic light controller as claimed in claim 1 wherein, the flashing red light is incorporated within a red light of the rest of the three light traffic lights.

3. The red light runner traffic light controller as claimed in claim 1 wherein, the flashing red light is separate from a red light of the rest of the three light traffic lights.

4. The red light runner traffic light controller as claimed in claim 1, wherein the sensor controller is a new sensor positioned to detect a red running vehicle in an area of the intersection of two lanes and the relay and the flashing circuit are incorporated in a new controller already designed to handle a three light traffic light system having sensors in the area of the lanes leading up to the intersection and the new sensor and flashing light are coupled to the new controller, and wherein the operations of controlling a red light runner are the same with input from the new sensor.

5. The red light runner traffic light controller as claimed in claim 2, wherein the sensor controller is a new sensor positioned to detect a red running vehicle in an area of the intersection of two lanes and the relay and the flashing circuit are incorporated in a new controller already designed to handle a three light traffic light system having sensors in the area of the lanes leading up to the intersection and the new sensor and flashing light are coupled to the new controller, and wherein the operations of controlling a red light runner are the same with input from the new sensor.

6. The red light runner traffic light controller as claimed in claim 3, wherein the sensor controller is a new sensor positioned to detect a red running vehicle in an area of the intersection of two lanes and the relay and the flashing circuit are incorporated in a new controller already designed to handle a three light traffic light system having sensors in the area of the lanes leading up to the intersection and the new sensor and flashing light are coupled to the new controller, and wherein the operations of controlling a red light runner are the same with input from the new sensor.

7. The red light runner traffic light controller as claimed in claim 1, wherein a red light camera receives activation signals from the original controller and the sensor controller to further assist in capturing an image of the red light running vehicle.

8. The red light runner traffic light controller as claimed in claim 2, wherein a red light camera receives activation signals from the original controller and the sensor controller to further assist in capturing an image of the red light running vehicle.

9. The red light runner traffic light controller as claimed in claim 3, wherein a red light camera receives activation signals from the original controller and the sensor controller to further assist in capturing an image of the red light running vehicle.

10. The red light runner traffic light controller as claimed in claim 4, wherein a red light camera receives activation signals from the new controller and the new sensor to further assist in capturing an image of the red light running vehicle.

11. The red light runner traffic light controller as claimed in claim 5, wherein a red light camera receives activation signals from the new controller and the new sensor to further assist in capturing an image of the red light running vehicle.

12. The red light runner traffic light controller as claimed in claim 6, wherein a red light camera receives activation signals from the new controller and the new sensor to further assist in capturing an image of the red light running vehicle.

12. A red light runner traffic light controller comprising,
a first sensor is positioned to detect a red running vehicle at a stop line of the intersection of two crossing lanes on both sides of the lanes,
a new controller is coupled to the first sensor to receive singles indicate a red running vehicle in the intersection of two lanes of traffic,
the new controller receives signals output from second sensor in lane areas leading up to the intersection of the red running vehicle,
a green light receiving output from the new controller,
a flashing red light coupled to an output of the new controller for the waiting lanes of the intersection,
wherein when the first sensor detects a red runner vehicle within the common area of the intersection and has received the output from the second sensors such that the red runner vehicle has passed the second sensors and the mew controller has decided to light a yellow light for a lane of the red runner vehicle, the new controller keeps the green light off for the waiting lanes opposing the red running vehicle to prevent the green light for lighting for traffic in the waiting lanes and sends output the flashing light of the waiting lanes;
wherein when the first sensor does not detect a red runner vehicle and the second sensor confirm recently stopped traffic the lanes of the red runner vehicle, the green light of the waiting lanes operates at normal timing and output of the red flashing light does not flash in the waiting lanes.

13. The red light runner traffic light controller as claimed in claim 12 wherein, the flashing red light is incorporated within a red light of the rest of the three light traffic lights.

14. The red light runner traffic light controller as claimed in claim 12 wherein, the flashing red light is separate from a red light of the rest of the three light traffic lights.

15. The red light runner traffic light controller as claimed in claim 1, wherein a red light camera receives activation signals from the new controller and the first and second sensors to further assist in capturing an image of the red light running vehicle.

16. The red light runner traffic light controller as claimed in claim 13, wherein a red light camera receives activation signals from the new controller and the first and second sensors to further assist in capturing an image of the red light running vehicle.

17. The red light runner traffic light controller as claimed in claim 14, wherein a red light camera receives activation signals from the new controller and the first and second sensors to further assist in capturing an image of the red light running vehicle.
